(19) United States
(12) Patent Application Publication
(10) Pub. No.: US 2025/0362224 A1
(43) Pub. Date: Nov. 27, 2025

(54) SPECTROSCOPIC MEASUREMENT DEVICE AND ARTICLE INSPECTION DEVICE INCLUDING THE SAME

(71) Applicant: ANRITSU CORPORATION, Kanagawa (JP)

(72) Inventors: Eiji TANIGUCHI, Kanagawa (JP); Jyunichi SANO, Kanagawa (JP); Tetsuro HINOKI, Kanagawa (JP)

(21) Appl. No.: 19/211,739

(22) Filed: May 19, 2025

(30) Foreign Application Priority Data
May 22, 2024 (JP) 2024-083381

(51) Int. Cl. G01N 21/31; G01N 21/84; G01N 21/88

(52) U.S. Cl. CPC G01N 21/31; G01N 21/88; G01N 2021/845; G01N 2201/08

(57) ABSTRACT

A spectroscopic measurement device capable of adjusting a light quantity acquired by a light detection unit to an appropriate light quantity is provided. The spectroscopic measurement device includes: a light source unit configured to emit light from a light source toward a tablet; and the light detection unit configured to measure a spectral characteristic of transmission light emitted from the light source unit and transmitted through the tablet with a spectroscope, in which the light source unit is configured such that a relative distance to the tablet is adjustable based on a control signal input from an outside, and the light detection unit is configured such that a relative distance to the tablet is adjustable based on a control signal input from an outside.

### TECHNICAL FIELD

The present invention relates to a spectroscopic measurement device and an article inspection device.

### BACKGROUND ART

Patent Document 1 discloses an inspection device including a light source and a sensor which is a light receiving element, the light source and the sensor interposing a molded product and a rotating body for transporting the molded product and being disposed to face each other along a vertical direction which is a rotation axis of the rotating body, in which the inspection device is configured to determine whether a foreign substance is mixed into the molded product and/or whether a component and another quality of the molded product are appropriate, by causing transmission light transmitted through the molded product in light or electromagnetic waves emitted from the light source to be incident on the sensor as signal light and analyzing the signal light.

### RELATED ART DOCUMENT

### Patent Document

[Patent Document 1] JP-A-2019-112199

### DISCLOSURE OF THE INVENTION

### Problem that the Invention is to Solve

Meanwhile, the transmittance of the molded product may vary significantly depending on physical properties of the molded product. Therefore, in a case of a device that performs transmission measurement, such as the inspection device described in Patent Document 1, there is a concern that, in a case where a molded product as a measurement target is changed, measurement data may be out of a measurable range of a light detection unit depending on physical properties of the changed molded product.

It is desirable that a light quantity acquired by the light detection unit can be adjusted in order to keep the measurement data within a measurement range of the light detection unit even in a case where the molded product as the measurement target is changed.

The present invention has been made in view of the above circumstances, and an object of the present invention is to provide a spectroscopic measurement device and an article inspection device capable of adjusting a light quantity acquired by a light detection unit to an appropriate light quantity.

### Means for Solving the Problem

According to a first aspect of the present invention, a spectroscopic measurement device includes: a light source unit configured to emit light from a light source toward an article; and a light detection unit configured to measure a spectral characteristic of transmission light emitted from the light source unit and transmitted through the article with a spectroscope, in which the light source unit and the light detection unit are configured such that a relative distance from the light source unit to the article and a relative distance from the light detection unit to the article are adjustable as adjustment targets.

With the configuration, in the spectroscopic measurement device according to the first aspect of the present invention, since the light source unit and the light detection unit are configured such that the relative distance from the light source unit to the article and the relative distance from the light detection unit to the article are adjustable, a light quantity acquired by the light detection unit can be adjusted to an appropriate light quantity by changing the relative distance from at least one of the light source unit or the light detection unit to the article.

According to a second aspect of the present invention, in the spectroscopic measurement device according to the first aspect, the light source unit and the light detection unit include actuators configured to adjust the relative distances to the article based on a control signal input from an outside.

With the configuration, in the spectroscopic measurement device according to the second aspect of the present invention, the actuator can be driven by the control signal input from a control device outside, and the relative distance to the article can be adjusted.

According to a third aspect of the present invention, in the spectroscopic measurement device according to the first aspect, the light detection unit includes a light receiving member including a light receiving end facing the article, and a light receiving fiber including an incidence end surface on which light transmitted through the light receiving member is incident, and the light receiving fiber is configured such that a relative distance from the incidence end surface to the article is adjustable as an adjustment target, and/or the light source unit includes a light projecting member including a light projecting end facing the article, and a light guide configured to guide the light of the light source from the light source to the light projecting member and including an emission end surface from which the light is emitted, and the light guide is configured such that a relative distance from the emission end surface to the article is adjustable as an adjustment target.

With the configuration, in the spectroscopic measurement device according to the third aspect of the present invention, since the light receiving fiber of the light detection unit is configured such that the relative distance from the incidence end surface to the article is adjustable, the light quantity acquired by the light detection unit can be adjusted to an appropriate light quantity by adjusting the relative distance from the incidence end surface of the light receiving fiber to the article, and/or, since the light guide is configured such that the relative distance from the emission end surface to the article is adjustable, the light quantity acquired by the light detection unit can be adjusted to an appropriate light quantity by adjusting the relative distance from the emission end surface of the light guide to the article.

According to a fourth aspect of the present invention, in the spectroscopic measurement device according to the third aspect, the light detection unit and/or light source unit includes an actuator configured to adjust the relative distance to the article based on a control signal input from an outside.

With the configuration, in the spectroscopic measurement device according to the fourth aspect of the present invention, the actuator can be driven by the control signal input from a control device outside, and the relative distance to the article can be adjusted.

According to a fifth aspect of the present invention, in the spectroscopic measurement device according to the first aspect, the light detection unit includes a light receiving member including a light receiving end facing the article, and a light receiving fiber including an incidence end surface on which light transmitted through the light receiving member is incident, and the light receiving member is configured such that a light receiving diameter, which is a size of an opening on which light from the article is incident in the light receiving end, is adjustable as an adjustment target, and/or the light source unit includes a light projecting member including a light projecting end facing the article, and a light guide configured to guide the light of the light source from the light source to the light projecting member and including an emission end surface from which the light is emitted, and the light projecting member is configured such that a light projecting diameter, which is a size of an opening from which the light from the light source is emitted in the light projecting end, is adjustable as an adjustment target.

With the configuration, in the spectroscopic measurement device according to the fifth aspect of the present invention, since the configuration is such that the light receiving diameter, which is the size of the opening on which light from the article is incident in the light receiving end of the light receiving member, is adjustable, the light quantity acquired by the light detection unit can be adjusted to an appropriate light quantity by adjusting the light receiving diameter of the light receiving end of the light receiving member, and/or, since the configuration is such that the light projecting diameter, which is the size of the opening from which the light from the light source is emitted in the light projecting end of the light projecting member, is adjustable, the light quantity acquired by the light detection unit can be adjusted to an appropriate light quantity by adjusting the light projecting diameter of the light projecting end of the light projecting member.

According to a sixth aspect of the present invention, in the spectroscopic measurement device according to the fifth aspect, the light detection unit and/or the light source unit includes an actuator configured to adjust the size of the opening based on a control signal input from an outside.

With the configuration, in the spectroscopic measurement device according to the sixth aspect of the present invention, the actuator can be driven by the control signal input from a control device outside, and the light quantity acquired by the light detection unit can be adjusted to an appropriate light quantity.

According to a seventh aspect of the present invention, in the spectroscopic measurement device according to the first aspect, the light detection unit includes a variable optical attenuator configured to attenuate the transmission light transferred to the spectroscope and configured to vary an attenuation amount of the transmission light as an adjustment target, and/or the light source is configured such that a light quantity of the emitted light is adjustable as an adjustment target.

With the configuration, in the spectroscopic measurement device according to the seventh aspect of the present invention, since the light detection unit includes the variable optical attenuator configured to attenuate the transmission light transferred to the spectroscope and configured to vary the attenuation amount of the transmission light, the light quantity acquired by the light detection unit can be adjusted to an appropriate light quantity by adjusting the attenuation amount of the transmission light transferred to the spectroscope with the variable optical attenuator, and/or, since the light source configured such that the light quantity of the emitted light is adjustable, the light quantity acquired by the light detection unit can be adjusted to an appropriate light quantity by adjusting the light quantity of the light source.

According to an eighth aspect of the present invention, an article inspection device includes: the spectroscopic measurement device according to the first aspect; and a control unit configured to adjust the adjustment targets, in which the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

According to a ninth aspect of the present invention, an article inspection device includes: the spectroscopic measurement device according to the third aspect; and a control unit configured to adjust the adjustment targets, in which the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

According to a tenth aspect of the present invention, an article inspection device includes: the spectroscopic measurement device according to the fifth aspect; and a control unit configured to adjust the adjustment targets, in which the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

With the configuration, in the article inspection device according to the eighth to tenth aspects of the present invention, since the control unit is configured to adjust the adjustment targets at the predetermined adjustment intervals, respectively record the spectra obtained by the spectroscope at the adjustment intervals, and set, as the light quantity adjustment value, the adjustment value of the adjustment targets corresponding to the spectrum in a case where the count value of the wavelength having the highest light quantity is equal to or less than the predetermined threshold value among the recorded spectra, the light quantity acquired by the light detection unit can be adjusted to an appropriate light quantity by the control unit. Further, the control unit can measure a spectral characteristic of the article with the adjusted light quantity adjustment value.

According to an eleventh aspect of the present invention, an article inspection device includes: the spectroscopic measurement device according to the first aspect; an inspection unit configured to inspect a quality of the article based on the spectral characteristic measured by the spectroscope; and a transport unit configured to transport the article to the spectroscopic measurement device, in which the article inspection device is configured such that an exposure time of the spectroscope is adjustable as an adjustment target by adjusting a transport speed of the transport unit.

According to a twelfth aspect of the present invention, an article inspection device includes: the spectroscopic measurement device according to the third aspect; an inspection unit configured to inspect a quality of the article based on the spectral characteristic measured by the spectroscope; and a transport unit configured to transport the article to the spectroscopic measurement device, in which the article inspection device is configured such that an exposure time of the spectroscope is adjustable as an adjustment target by adjusting a transport speed of the transport unit.

According to a thirteenth aspect of the present invention, an article inspection device includes: the spectroscopic measurement device according to the fifth aspect; an inspection unit configured to inspect a quality of the article based on the spectral characteristic measured by the spectroscope; and a transport unit configured to transport the article to the spectroscopic measurement device, in which the article inspection device is configured such that an exposure time of the spectroscope is adjustable as an adjustment target by adjusting a transport speed of the transport unit.

With the configuration, since the article inspection device according to the eleventh to thirteenth aspects of the present invention is configured such that the exposure time of the spectroscope is adjustable by adjusting the transport speed of the transport unit, the light quantity acquired by the light detection unit can be adjusted to an appropriate light quantity by adjusting the exposure time of the spectroscope.

According fourteenth aspect of the present invention, the article inspection device according to the eleventh aspect further includes: a control unit configured to adjust the adjustment targets, in which the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

According to a fifteenth aspect of the present invention, the article inspection device according to the twelfth aspect further includes: a control unit configured to adjust the adjustment targets, in which the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

According to a sixteenth aspect of the present invention, the article inspection device according to the thirteenth aspect further includes: a control unit configured to adjust the adjustment targets, in which the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

With the configuration, in the article inspection device according to the fourteenth to sixteenth aspects of the present invention, since the control unit is configured to adjust the adjustment targets at the predetermined adjustment intervals, respectively record the spectra obtained by the spectroscope at the adjustment intervals, and set, as the light quantity adjustment value, the adjustment value of the adjustment targets corresponding to the spectrum in a case where the count value of the wavelength having the highest light quantity is equal to or less than the predetermined threshold value among the recorded spectra, the light quantity acquired by the light detection unit can be adjusted to an appropriate light quantity by the control unit. Further, the control unit can measure a spectral characteristic of the article with the adjusted light quantity adjustment value.

According to a seventeenth aspect of the present invention, in the article inspection device according to the fourteenth aspect, the transport unit is configured to hold the article on an end surface different from an irradiation-side surface and a transmission-side surface and move the article.

According to an eighteenth aspect of the present invention, in the article inspection device according to the fifteenth aspect, the transport unit is configured to hold the article on an end surface different from an irradiation-side surface and a transmission-side surface and move the article.

According to a nineteenth aspect of the present invention, in the article inspection device according to the sixteenth aspect, the transport unit is configured to hold the article on an end surface different from an irradiation-side surface and a transmission-side surface and move the article.

With the configuration, in the article inspection device according to the seventeenth to nineteenth aspects of the present invention, since stable transportation is achieved while exposing the irradiation-side surface, which is a lower surface side of the article irradiated with the light from the light source unit, and the transmission-side surface, which is an upper surface side of the article through which the transmission light passes, inspection can be performed with high accuracy even while moving the article.

According to a twentieth aspect of the present invention, in the article inspection device according to the seventeenth aspect, the article is a tablet. With the configuration, the article inspection device according to the twentieth aspect of the present invention can also be applied to a case where the article as an inspection target is a tablet.

### Advantage of the Invention

According to the present invention, it is possible to provide a spectroscopic measurement device and an article inspection device capable of adjusting a light quantity acquired by a light detection unit to an appropriate light quantity.

### BRIEF DESCRIPTION OF THE DRAWINGS

FIG. 1 is a schematic configuration diagram of a spectroscopic measurement device according to an embodiment of the present invention.

FIG. 2 is a schematic block diagram of an article inspection device including the spectroscopic measurement device according to the embodiment of the present invention.

FIG. 3 is a plan view showing a spectroscopic measurement device and a transport disk according to the embodiment of the present invention.

FIG. 4 is a graph showing spectra of a plurality of patterns recorded by light quantity adjustment control.

FIG. 5 is a graph showing a relationship between light source output and a count value recorded by the light quantity adjustment control.

### BEST MODE FOR CARRYING OUT THE INVENTION

Hereinafter, an article inspection device including a spectroscopic measurement device according to an embodiment of the present invention will be described with reference to the drawings.

In a case where an article as an inspection target, which is individually transported by a transport unit through a transport t passage, reaches predetermined inspection position, the article inspection device according to the present embodiment irradiates the article, which is in a certain posture, with light at the predetermined inspection position, and inspects a quality of the article based on a spectral characteristic of transmission light transmitted through the article in association with the irradiation of the light (also referred to as irradiation light).

The article as the inspection target is an article having a size relatively close to an area irradiated with light, and includes an article having an outer diameter φ: several mm to several tens mm, which can be individually transported without being packaged, an article having a bite size, and an article or molded product having a predetermined shape and manufactured by existing manufacturing equipment or manufacturing equipment without an inspection function, particularly an article whose shape does not change in a transport process.

Examples of the article include a preparation, such as a tablet, a capsule, a troche, and a drop, a candy, chocolate, and the like. Hereinafter, as the article as the inspection target, a tablet W having a circular shape in a plan view and a substantially shallow columnar shape in a side view having a small height (thickness) compared to a diameter will be described as an example. The article as the inspection target is not limited to a circular shape in a plan view, and articles having various shapes such as an elliptical shape and a polygonal shape can be applied.

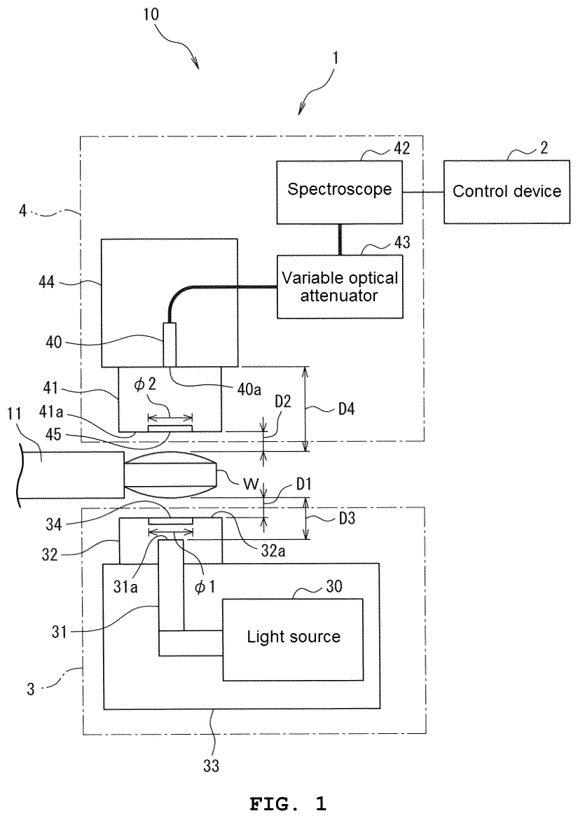

In addition, examples of the transport unit include a transport unit having a configuration in which articles are aligned and individually transported, such as a transport belt, a transport disk, and a transport chute. In the present embodiment, an example in which a transport disk 11 (refer to FIG. 1) is used as the transport unit will be described.

As shown in FIG. 1, the transport disk 11 is a transport unit having a configuration in which the tablet W is sucked to a suction hole on an outer peripheral surface thereof and transported in a circumferential direction while being laterally rotated. In the transport disk 11, the tablet W is transported in a state where an upper surface and a lower surface are horizontally maintained by a side surface being sucked to the suction hole. In FIG. 1, only a part of an outer peripheral side of the transport disk 11 is shown.

An article inspection device 10 according to the present embodiment includes a spectroscopic measurement device 1 and a control device 2.

### [Spectroscopic Measurement Device]

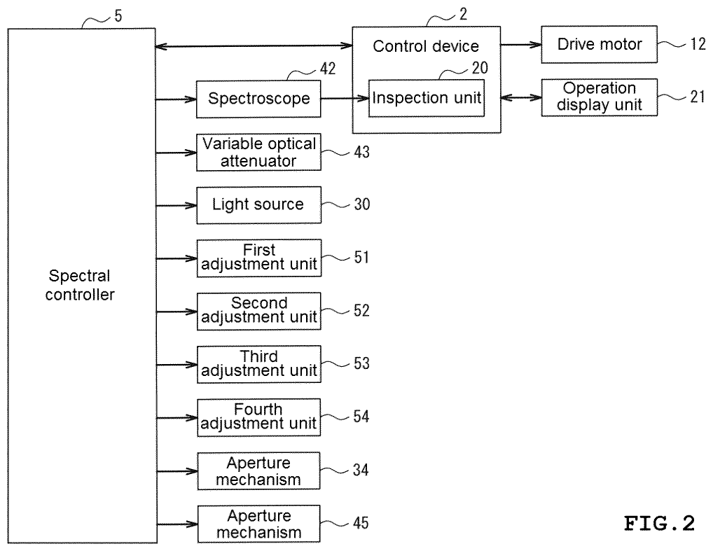

The spectroscopic measurement device 1 includes a light source unit 3, a light detection unit 4, and a spectral controller 5 (refer to FIG. 2). The spectroscopic measurement device 1 irradiates the tablet W as a measurement target with broadband light (visible light and near-infrared to terahertz light (terahertz waves)), and measures a spectral characteristic of light transmitted through the tablet W in association with the irradiation of the light. In the present embodiment, the above-described control device 2 and spectral controller 5 constitute a control unit.

### (Light Source Unit)

The light source unit 3 irradiates the tablet W passing through the predetermined inspection position, that is, the tablet W during transportation (movement) with broadband light. In the present embodiment, the light source unit 3 is disposed on a side opposite to the light detection unit 4 (in the present embodiment, a lower side) with the transport passage of the tablet W interposed therebetween such that the light source unit 3 emits light from one side (in the present embodiment, the lower side) of a pair of circular end surfaces of the tablet W having a substantially shallow columnar shape toward the other side (in the present embodiment, an upper side).

The transport passage of the tablet W is a region through which the tablet W passes during transportation. In addition, the predetermined inspection position is a position at which the light source unit 3 and the light detection unit 4 are disposed in the transport passage of the tablet W.

The light source unit 3 includes a light source 30, a light guide 31, and a light projecting member 32.

The light source 30 is configured with a broadband light source represented by, for example, a halogen lamp in order to irradiate the tablet W as the measurement target with broadband light, and is provided at a predetermined position as a light source unit that is integrally assembled with a case in which lamp holding means and a heat dissipation fin (not shown) are formed, and is connected to a power supply unit (neither of which shown).

The broadband light refers to light including visible light and near-infrared to terahertz light (terahertz waves). It should be noted that a wavelength of light to be emitted does not need to cover all of the above, and for example, in a wavelength band of 400 to 2500 nm, an object to be measured such as a tablet is likely to be transmitted, and damage due to ultraviolet rays is unlikely to be applied, and thus the wavelength may be limited to the wavelength band or a near-infrared band within the wavelength band. In addition, in a case where an absorption spectrum of a component to be measured is known, only a wavelength band corresponding to the absorption spectrum may be used.

The light source 30 is configured such that a light quantity of the emitted light is adjustable. For example, the light source 30 is connected to the spectral controller 5 described later, and the light quantity can be adjusted by adjusting light source output based on an instruction from the spectral controller 5.

In addition, the light source 30 may have a light control unit that incorporates a light reduction plate (not shown), and the light source 30 may be configured to adjust the light quantity with the light control unit. In this case, the light source 30 is connected to the spectral controller 5 described later, and the light quantity can be adjusted by controlling the light control unit based on an instruction from the spectral controller 5.

The light guide 31 is configured by bundling a large number of glass optical fibers, and guides light of the light source 30 from the light source 30 to the light projecting member 32. The light guide 31 has an emission end surface 31a from which light from the light source 30 is emitted.

The light guide 31 has an emission end surface 31a facing the tablet W via the light projecting member 32 at an end portion on a side opposite to the light source 30 (in the present embodiment, the upper side). The light emitted from the light source 30 is emitted from the emission end surface 31a of the light guide 31 toward the light projecting member 32. In the present embodiment, the emission end surface 31a means a distal end surface of a light guide in which glass optical fibers are bundled in a bundle shape, and does not include an outer peripheral portion that covers the emission end surface 31a.

The light source 30 and the light guide 31 are accommodated in a light source unit main body 33 consisting of a housing. The light source unit main body 33 need only have a structure with which the light source 30 and the light guide 31 can be integrally supported, and is not limited to a housing, and may be formed of, for example, a bracket.

The light projecting member 32 is disposed on an emission end surface 31a side of the light guide 31, and specifically, is disposed above the light source unit main body 33. The light projecting member 32 is fixed to an upper surface of the light source unit main body 33 by a fastening member (not shown).

The light projecting member 32 includes a light projecting end 32a facing the tablet W at an end portion on a side opposite to the light source unit main body 33 (in the present the upper side). The light projecting member 32 includes, for example, a member having a tubular shape or a hollow shape in which a passage through which light passes is formed.

An aperture mechanism 34 that is capable of adjusting a size of an opening through which the light of the light source 30 emitted from the emission end surface 31a of the light guide 31 is emitted, that is, a diameter (hereinafter, referred to as a “light projecting diameter”) φ1 of the opening is provided at the light projecting end 32a.

The aperture mechanism 34 may have any configuration as long as the light projecting diameter φ1 can be adjusted, and for example, an iris consisting of a plurality of movable blades can be used. The aperture mechanism 34 includes, for example, a stepping motor as a drive source that drives a mechanism such as a plurality of movable blades, which is capable of adjusting the light projecting diameter φ1. The aperture mechanism 34 is connected to the spectral controller 5 described later, and the driving of the drive source is controlled based on an instruction from the spectral controller 5, so that the light projecting diameter φ1 can be adjusted.

The tablet W is irradiated with the light emitted from the light source 30 via the light guide 31 and the light projecting member 32.

### (Light Detection Unit)

The light detection unit 4 is disposed on a side opposite to the light source unit 3 (in the present embodiment, the upper side) with the transport passage of the tablet W interposed therebetween such that the light detection unit 4 faces an end surface on the other side (in the present embodiment, the upper side) of a pair of circular end surfaces of the tablet W having the substantially shallow columnar shape.

The light detection unit 4 includes a light receiving fiber 40, a light receiving member 41, a spectroscope 42, and a variable optical attenuator (VOA) 43.

The light receiving fiber 40 receives the transmission light transmitted through the tablet W at the predetermined inspection position through the light receiving member 41. The transmission light that is transmitted through the tablet W and passes through the light receiving member 41 is incident on the light receiving fiber 40 from an end surface (hereinafter, referred to as an “incidence end surface”) 40a of an incidence surface of the light receiving fiber 40. The transmission light incident on the light receiving fiber 40 passes through the light receiving fiber 40 and reaches the spectroscope 42 via the variable optical attenuator 43.

As the light receiving fiber 40, a tapered optical fiber having a shape in which a diameter of an input is large and a diameter of an output is small can be used. As a result, the transmission light can be more efficiently incident on the spectroscope 42.

The light receiving fiber 40 is accommodated in a light receiving section main body 44 consisting of a housing. The light receiving section main body 44 need only have a structure with which the light receiving fiber 40 can be supported, and is not limited to a housing, and may be formed of, for example, a bracket. The light receiving section main body 44 may be capable of integrally supporting the spectroscope 42 and the variable optical attenuator 43 in addition to the light receiving fiber 40.

The light receiving member 41 is disposed on an incidence end surface 40a side of the light receiving fiber 40, and specifically, is disposed below the light receiving section main body 44. The light receiving member 41 is fixed to a lower surface of the light receiving section main body 44 by a fastening member (not shown).

The light receiving member 41 has a light receiving end 41a facing the tablet W at an end portion on a side opposite to the light receiving section main body 44 (in the present embodiment, the lower side). The light receiving member 41 includes, for example, a member having a tubular shape or a hollow shape in which a passage through which light passes is formed.

An aperture mechanism 45 that is capable of adjusting a size of an opening on which the light transmitted through the tablet W is incident, that is, a diameter (hereinafter, referred to as a “light receiving diameter”) 42 of the opening is provided at the light receiving end 41a.

The aperture mechanism 45 may have any configuration as long as the light receiving diameter φ2 can be adjusted, as in the aperture mechanism 34, and for example, an iris consisting of a plurality of movable blades can be used. The aperture mechanism 45 includes, for example, a stepping motor as a drive source that drives a mechanism such as a plurality of movable blades, which is capable of adjusting the light receiving diameter φ2. The aperture mechanism 45 is connected to the spectral controller 5 described later, and the driving of the drive source is controlled based on an instruction from the spectral controller 5, so that the light receiving diameter 42 can be adjusted.

The spectroscope 42 performs, for example, spectral separation through a grating using a difference in a diffraction angle depending on the wavelength of light. Specifically, the light entering the spectroscope 42 is emitted to the grating (diffraction grating) and is spectrally separated into wavelength components. Then, the light spectrally separated into the wavelength components is detected by light detection elements arranged in one row for each wavelength component. Then, light intensity for each wavelength component is measured. The grating is an optical element in which a plurality of grooves are engraved on a surface.

The variable optical attenuator 43 is provided on an optical path between the light receiving fiber 40 and the spectroscope 42. The variable optical attenuator 43 is configured to attenuate the transmission light transferred from the light receiving fiber 40 to the spectroscope 42 and to change an attenuation amount of the transmission light. The variable optical attenuator 43 is connected to the spectral controller 5 described later, and can change an attenuation amount of the light intensity based on an instruction from the spectral controller 5.

As described above, the light detection unit 4 receives the transmission light, which is emitted from the light source unit 3 and transmitted through the tablet W, with the light receiving fiber 40 through the light receiving member 41, and measures the spectral characteristic of the transmission light transferred through the variable optical attenuator 43 with the spectroscope 42.

### (Spectral Controller)

As shown in FIG. 2, a first adjustment unit 51, a second adjustment unit 52, a third adjustment unit 53, and a fourth adjustment unit 54 are connected to the spectral controller 5 in addition to the control device 2, the spectroscope 42, the variable optical attenuator 43, the light source 30, the aperture mechanism 34, and the aperture mechanism 45.

As shown in FIG. 1, the first adjustment unit 51 adjusts a relative distance D1 from the light source unit 3 to the tablet W. In other words, the first adjustment unit 51 moves the light source unit 3 in a direction (in the present embodiment, a vertical direction) in which the light source unit 3 approaches or separates from the tablet W.

The first adjustment unit 51 may be any mechanism as long as a position of the light source unit 3 can be adjusted, and for example, an adjustment mechanism such as ELECYLINDER (registered trademark), a rack and pinion mechanism, or a ball screw mechanism, or a combination of these adjustment mechanisms can be used, and various actuators that drive these adjustment mechanisms are further provided.

The spectral controller 5 controls the driving of the actuator of the first adjustment unit 51 to adjust the relative distance D1 from the light source unit 3 to the tablet W (the lower surface of the tablet).

Here, the distance D1 is a distance between the light projecting member 32 and the tablet W, specifically, a distance between the light projecting end 32a of the light projecting member 32 and the lower surface of the tablet W. Therefore, adjusting the distance D1 with the first adjustment unit 51 corresponds to adjusting the distance between the light projecting member 32 and the tablet W.

The second adjustment unit 52 adjusts a relative distance D2 from the light detection unit 4 to the tablet W. In other words, the second adjustment unit 52 moves the light detection unit 4 in a direction (in the present embodiment, the vertical direction) in which the light detection unit 4 approaches or separates from the tablet W. The light receiving member 41 and the light receiving section main body 44 may be moved while the spectroscope 42 and the variable optical attenuator 43 are kept in their positions.

Similarly to the first adjustment unit 51, the second adjustment unit 52 may be any mechanism as long as a position of the light detection unit 4 can be adjusted, and for example, an adjustment mechanism such as ELECYLINDER (registered trademark), a rack and pinion mechanism, or a ball screw mechanism, or a combination of these adjustment mechanisms can be used, and various actuators that drive these adjustment mechanisms are further provided.

The spectral controller 5 controls the driving of the actuator of the second adjustment unit 52 to adjust the relative distance D2 from the light detection unit 4 to the tablet W (the upper surface of the tablet).

Here, the distance D2 is a distance between the light receiving member 41 and the tablet W, specifically, a distance between the light receiving end 41a of the light receiving member 41 and the upper surface of the tablet W. Therefore, adjusting the distance D2 with the second adjustment unit 52 corresponds to adjusting the distance between the light receiving member 41 and the tablet W.

The third adjustment unit 53 adjusts a relative distance D3 from the emission end surface 31a of the light guide 31 to the tablet W. In other words, the third adjustment unit 53 moves the emission end surface 31a of the light guide 31 in a direction (in the present embodiment, the vertical direction) in which the emission end surface 31a of the light guide 31 approaches or separates from the tablet W.

The third adjustment unit 53 may be any mechanism as long as a position of the emission end surface 31a of the light guide 31 can be adjusted, and for example, an adjustment mechanism such as ELECYLINDER (registered trademark), a rack and pinion mechanism, or a ball screw mechanism, or a combination of these adjustment mechanisms can be used, and various actuators that drive these adjustment mechanisms are further provided.

The spectral controller 5 controls the driving of the actuator of the third adjustment unit 53 to adjust the relative distance D3 from the emission end surface 31a of the light guide 31 to the tablet W (the lower surface of the tablet).

The fourth adjustment unit 54 adjusts a relative distance D4 from the incidence end surface 40a of the light receiving fiber 40 to the tablet W. In other words, the fourth adjustment unit 54 moves the incidence end surface 40a of the light receiving fiber 40 in a direction (in the present embodiment, the vertical direction) in which the incidence end surface 40a of the light receiving fiber 40 approaches or separates from the tablet W.

Similarly to the third adjustment unit 53, the fourth adjustment unit 54 may be any mechanism as long as a position of the incidence end surface 40a of the light receiving fiber 40 can be adjusted, and for example, an adjustment mechanism such as ELECYLINDER (registered trademark), a rack and pinion mechanism, or a ball screw mechanism, or a combination of these adjustment mechanisms can be used, and various actuators that drive these adjustment mechanisms are further provided.

The spectral controller 5 controls the driving of the actuator of the fourth adjustment unit 54 to adjust the relative distance D4 from the incidence end surface 40a of the light receiving fiber 40 to the tablet W (the upper surface of the tablet).

### [Control Device]

The control device 2 is connected to the spectral controller 5 in a bidirectional communicable manner, and includes an inspection unit 20.

The inspection unit 20 includes a signal processing unit (not shown) that performs signal processing on the spectral characteristic obtained by the light detection unit 4 within a predetermined exposure time, and inspects a quality of the tablet W, that is, performs good/bad determination of the quality of the tablet W from a result of the signal processing.

The signal processing unit calculates a spectral characteristic in an absorbance of the tablet W from the spectral characteristic obtained by the light detection unit 4. Specifically, an absorbance A at a wavelength λ is obtained by an equation A=−log 10 (I/Ii) of a common logarithm of a ratio of light intensity Ii of incident light to light intensity of I transmission light the (transmittance), and a transmission amount detected in a state where the tablet W is not present at the predetermined inspection position can be obtained as the light intensity Ii of the incident light.

The inspection unit 20 compares a spectral characteristic (intensity of each wavelength of the spectrum (including a case of being differentiated multiple times), a shape of a waveform, information obtained by extracting the entire or a part of a region and providing a calibration curve thereof, and statistical information) in an absorbance of a good product of the tablet W acquired in advance with the spectral characteristic in the absorbance of the tablet W as the inspection target, which is transported to the predetermined inspection position, and determines whether or not the quality of the tablet W is good based on the magnitude of a difference thereof. The inspection unit 20 outputs a selection signal based on a good/bad result of the determination to a selection unit (not shown) that selects the tablet W as a normal product or a defective product.

Specifically, whether or not the quality of the tablet W is good is determined, for example, based on whether or not a differential amount for each wavelength defined by calculation using a calibration curve obtained by a statistical calculation result (such as standard deviation), a statistical method such as regression, or the like is within a predetermined range (a range defined based on a statistical calculation result or a result of calibration curve). In addition, it is also possible to determine whether or not the quality of the tablet W is good based on whether or not total intensity of wavelengths is within a predetermined range. Further, in a case where the components of the tablet W are uniform, whether or not the quality of the tablet W is good may be determined based on whether or not there is intensity exceeding a predetermined threshold value set in advance in a region other than a specific wavelength.

The control device 2 is configured to execute a light quantity adjustment control of adjusting a light quantity of transmission light acquired by the light detection unit 4 to an appropriate light quantity in a case where the type of measurement target of the spectroscopic measurement device 1 is changed, for example, in a case where one type of tablet W is changed to another type of tablet W1.

A drive motor 12 and an operation display unit 21 are connected to the control device 2. The drive motor 12 consists of, for example, a stepping motor and functions as a drive source of the transport disk 11. The control device 2 can control the driving of the drive motor 12 to adjust a rotation speed of the transport disk 11, that is, a transport speed of the tablet W. Accordingly, the control device 2 can adjust an exposure time of the spectroscope 42.

The operation display unit 21 consists of, for example, a touch panel type display, is operated by a user, and performs various settings and various displays. Note that a configuration in which an operation unit and a display unit are separately provided may be adopted.

On the operation display unit 21, an image of an inspection result or the like of the control device 2 is displayed, or various setting information or the like is displayed, for example. The control device 2 activates a mode in which the above-described light quantity adjustment control is executed through the operation of the operation display unit 21. The light quantity adjustment control may be executed based on, for example, a signal from an external computer connected to the control device 2, in addition to the operation through the operation display unit 21.

### [Regarding Light Quantity Adjustment Control]

In a case where one type of tablet W, which is the measurement target of the spectroscopic measurement device 1, is changed to another type of tablet W1, the control device 2 controls at least any one of the first adjustment unit 51 or the second adjustment unit 52 through the spectral controller 5 to automatically adjust the light source unit 3 or the light detection unit 4, or both of the light source unit 3 and the light detection unit 4 to initial positions corresponding to the changed tablet W1.

The initial positions may be stored in advance in a ROM of the control device 2 for each measurement target, or may be calculated based on the measurement target input through the operation display unit 21.

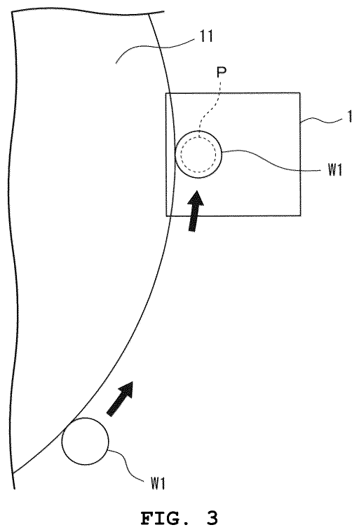

Next, as shown in FIG. 3, the control device 2 drives the drive motor 12 by a drive amount determined in advance, so that a sample of the changed tablet W1 attracted to the transport disk 11 is automatically transported to a measurement position P of the spectroscopic measurement device 1, that is, the predetermined inspection position.

The sample of the tablet W1 is attracted to an attraction position of the transport disk 11 designated by the user before the automatic transportation by, for example, marking. Here, the control device 2 returns the drive motor 12 to the origin before the sample of the tablet W1 is attracted to the transport disk 11. The return to the origin may be performed before the adjustment of the light source unit 3 and the light detection unit 4 to the initial positions.

Next, the control device 2 or the spectral controller 5 performs adjustment corresponding to one or more adjustment items among the following adjustment items (1) to (9). In other words, the control device 2 or the spectral controller 5 adjusts one or more adjustment targets among the adjustment targets, which are the exposure time, the attenuation amount of transmission light, the light quantity of the light source, the distance D1, the distance D2, the distance D3, the distance D4, the light projecting diameter φ1, and the light receiving diameter φ2. Among the adjustment items (1) to (9), which adjustment item is to be adjusted is designated in advance by the user. For example, the user designates one or more adjustment items through the operation display unit 21 before the light quantity adjustment control is performed. The control device 2 or the spectral controller 5 performs adjustment corresponding to the designated adjustment item. Each of the following adjustments (1) to (9) is automatically performed by the control device 2 or the spectral controller 5.
(1) Adjustment of Exposure Time
(2) Adjustment through Variable Optical Attenuator 43
(3) Adjustment of Light Quantity of Light Source 30
(4) Adjustment of Distance D1
(5) Adjustment of Distance D2
(6) Adjustment of Distance D3
(7) Adjustment of Distance D4
(8) Adjustment of Light Projecting Diameter φ1
(9) Adjustment of Light Receiving Diameter φ2

Here, a case where the light quantity of the light source 30 in (3) among the adjustment items (1) to (9) is adjusted will be described.

The control device 2 decreases light source output from adjustment start output determined in advance at predetermined adjustment intervals (for example, predetermined ratios) and records the spectrum for each light source output. That is, the control device 2 alternately performs the recording of the spectrum and the decrease in the light source output, and records the spectrum at the time of each light source output. The recording of the spectrum is performed for the predetermined number of times of adjustment determined in advance (including a case of the adjustment start output).

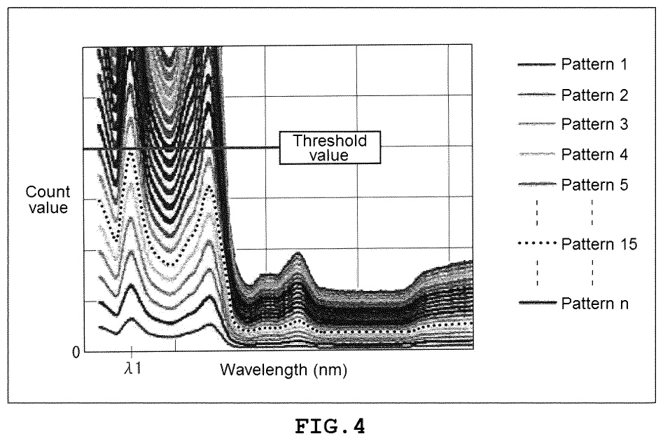

Each pattern of the recorded spectrum n for the predetermined number of times of adjustment is as shown in FIG. 4, for example. In the example shown in FIG. 4, the spectra of n patterns corresponding to the predetermined number of times of adjustment are recorded.

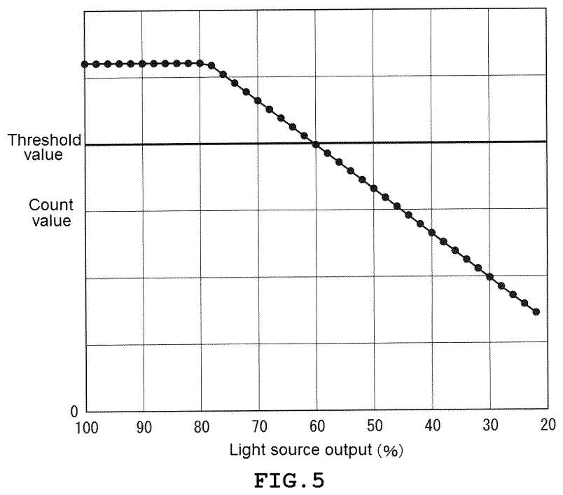

In this case, the control device 2 records the light quantity (for example, a count value) of a target wavelength λ1 at the time of each light source output, with a wavelength having the highest light quantity (or a wavelength having the highest brightness value) in the spectrum to be recorded as the target wavelength λ1. For example, the count value of the target wavelength λ1 in a case where the light source output is decreased by 2% from the adjustment start output is as shown in FIG. 5. The predetermined number of times of adjustment in the example shown in FIG. 5 is 40.

Then, the control device 2 completes the adjustment of the light source output corresponding to the pattern of the spectrum (in the example shown in FIG. 4, the pattern 15) in a case where the count value of the target wavelength λ1 is equal to or less than a predetermined threshold value (refer to FIG. 4) as a light quantity adjustment value. For example, in the example shown in FIG. 5, the light source output 60% is the light quantity adjustment value. After the adjustment is completed, the control device 2 and the spectral controller 5 measure the tablet W as the measurement target with the light source output of the light quantity adjustment value. The light quantity adjustment value may be used as the light source output at the measurement immediately before the light quantity adjustment value is equal to or less than the predetermined threshold value.

The predetermined threshold value is determined based on the following criteria.

it is known that the absorbance and the transmittance vary depending on a thickness of the tablet W1. In a case where the actual operation of the article inspection device 10 is performed, the tablet W1 having a thickness different from that of the sample of the tablet W1 used in the light quantity adjustment control is often measured, and the variation in the light quantity is large due to the variation in the thickness. In particular, in a case where the thickness of the tablet W1 is small, there is a concern that the count value of the spectrum obtained by the spectroscope 42 may be out of a measurement range of the spectroscope 42. The measurement range of the spectroscope 42 is a range of A/D conversion of the spectroscope and varies depending on the specifications of the spectroscope 42.

In addition, in a case of creating a calibration curve, the transmittance may be further different as the tablets W1 having different main components are measured.

Therefore, it is preferable that the predetermined threshold value is set to a value obtained by decreasing, by about 20% to 30%, the value at which the count value of the spectroscope 42 is outside the measurement range.

The control device 2 may have a pattern in which the light source output is increased from the adjustment start output determined in advance at predetermined adjustment intervals (for example, predetermined ratios). In this case, the control device 2 sets the light source output corresponding to the pattern of the spectrum in a case where the count value of the target wavelength λ1 is equal to or greater than the predetermined threshold value, or the light source output at the measurement immediately before the count value of the target wavelength λ1 is equal to or greater than the predetermined threshold value, as the light quantity adjustment value.

In the above description, the adjustment of the light quantity of the light source 30 in (3) has been described. However, in the same manner as in (3), the recording of the spectrum and the adjustment of the parameter corresponding to each adjustment item are performed for a predetermined number of times at predetermined adjustment intervals in (1), (2), and (4) to (9). It should be noted that, in the same manner as in (3), an adjustment start value, the predetermined adjustment intervals, and the predetermined number of times of adjustment of each parameter are determined in advance for (1), (2), and (4) to (9).

For example, in the adjustment item in (1), the predetermined adjustment intervals are set to predetermined time intervals, and the exposure time corresponding to the pattern of the spectrum in a case where the count value of the target wavelength λ1 is equal to or less than a predetermined threshold value is set as the light quantity adjustment value. In this case, after the adjustment is completed, the control device 2 and the spectral controller 5 measure the tablet W as the measurement target for the exposure time of the above-described light quantity adjustment value.

In the adjustment item in (2), the predetermined adjustment intervals are set to predetermined attenuation amount intervals, and the attenuation amount corresponding to the pattern of the spectrum in a case where the count value of the target wavelength λ1 is equal to or less than the predetermined threshold value is set as the light quantity adjustment value. In this case, after the adjustment is completed, the control device 2 and the spectral controller 5 measure the tablet W as the measurement target with the above-described attenuation amount of the light quantity adjustment value.

In the adjustment items in (4) to (7), the predetermined adjustment intervals are set to predetermined movement amount (for example, 0.1 mm) intervals, and each distance corresponding to the pattern of the spectrum in a case where the count value of the target wavelength λ1 is equal to or less than the predetermined threshold value is set as the light quantity adjustment value. In this case, after the adjustment is completed, the control device 2 and the spectral controller 5 measure the tablet W as the measurement target at the distances of the respective light quantity adjustment values.

In performing the adjustment in (4) to (7), the distance D3 may be adjusted while the distance D1 is fixed or the distance D4 may be adjusted while the distance D2 is fixed.

In the adjustment items in (8) and (9), the predetermined adjustment intervals are set to predetermined diameter variation amounts, and the light quantity adjustment value is set to the light projecting diameter and the light receiving diameter corresponding to the pattern of the spectrum in a case where the count value of the target wavelength λ1 is equal to or less than the predetermined threshold value. In this case, after the adjustment is completed, the control device 2 and the spectral controller 5 measure the tablet W as the measurement target in terms of the light projecting diameter or the light receiving diameter with the above-described light quantity adjustment value or in terms of both.

Next, a case where two adjustment items are combined and adjusted among the adjustment items in (1) to (9) will be described.

The control device 2 performs, while performing the adjustment of one adjustment item, the adjustment of another adjustment item at each predetermined adjustment interval for each predetermined adjustment interval of the one adjustment item. That is, the adjustment of the one adjustment item and the adjustment of the other adjustment item are performed by brute force for each adjustment interval. Then, the control device 2 determines a count value closest to the predetermined threshold value among the count values of the target wavelength λ1 obtained by the adjustment performed by the brute force, and sets a value of a parameter of the one adjustment item and a value of a parameter of the other adjustment item in a case where the count value is obtained, as the light quantity adjustment value.

### [Actions and Effects]

As described above, with the spectroscopic measurement device according to the present embodiment, since the light source unit 3 is configured such that the relative distance D1 to the tablet W is adjustable, the distance between the light projecting member 32 and the tablet W can be adjusted by changing the relative distance D1 from the light source unit 3 to the tablet W, and the light quantity acquired by the light detection unit 4 can be adjusted to an appropriate light quantity.

In addition, with the spectroscopic measurement device according to the present embodiment, since the light detection unit 4 is configured such that the relative distance D2 to the tablet W is adjustable, the distance between the light receiving member 41 and the tablet W can be adjusted by changing the relative distance D2 from the light detection unit 4 to the tablet W, and the light quantity acquired by the light detection unit 4 can be adjusted to an appropriate light quantity.

In addition, with the spectroscopic measurement device according to the present embodiment, since the light receiving fiber 40 of the light detection unit 4 is configured such that the relative distance D4 from the incidence end surface 40a to the tablet W is adjustable, the light quantity acquired by the light detection unit 4 can be adjusted to an appropriate light quantity even by adjusting the relative distance D4 from the incidence end surface 40a of the light receiving fiber 40 to the tablet W.

In addition, with the spectroscopic measurement device according to the present embodiment, since the light receiving diameter 92, which is the size of the opening on which the light from the tablet W is incident in the light receiving end 41a of the light receiving member 41, is configured to be adjustable, the light quantity acquired by the light detection unit 4 can be adjusted to an appropriate light quantity even by adjusting the light receiving diameter φ2 of the light receiving end 41a of the light receiving member 41.

In addition, with the spectroscopic measurement device according to the present embodiment, since the light detection unit 4 includes the variable optical attenuator 43 that can attenuate the transmission light transmitted to the spectroscope 42 and can change the attenuation amount of the transmission light, the light quantity acquired by the light detection unit 4 can be adjusted to an appropriate light quantity even by adjusting the attenuation amount of the transmission light transmitted to the spectroscope 42 with the variable optical attenuator 43.

In addition, with the spectroscopic measurement device according to the present embodiment, since the light guide 31 is configured such that the relative distance D3 from the emission end surface 31a to the tablet W is adjustable, the light quantity acquired by the light detection unit 4 can be adjusted to an appropriate light quantity even by adjusting the relative distance D3 from the emission end surface 31a of the light guide 31 to the tablet W.

In addition, with the spectroscopic measurement device according to the present embodiment, since the light projecting diameter φ1, which is the size of the opening through which the light from the light source 30 is emitted in the light projecting end 32a of the light projecting member 32, is configured to be adjustable, the light quantity acquired by the light detection unit 4 can be adjusted to an appropriate light quantity even by adjusting the light projecting diameter 1 of the light projecting end 32a of the light projecting member 32.

In addition, with the spectroscopic measurement device according to the present embodiment, since the light source 30 is configured to adjust the light quantity of the light to be emitted, the light quantity acquired by the light detection unit 4 can be adjusted to an appropriate light quantity even by adjusting the light quantity of the light source 30.

With the article inspection device according to the present embodiment, since the configuration is such that the exposure time of the spectroscope 42 can be adjusted by adjusting the transport speed of the transport disk 11, the light quantity acquired by the light detection unit 4 can be adjusted to an appropriate light quantity even by adjusting the exposure time of the spectroscope 42.

### Modification Example

In the present embodiment, the configuration in which the light projecting diameter φ1 can be adjusted by the aperture mechanism 34 has been described, but the present invention is not limited to this, and for example, the light projecting diameter φ1 may be adjusted by replacing the light projecting member 32 with a light projecting member having a different light projecting diameter. In this case, the aperture mechanism 34 is not necessary.

In addition, in the present embodiment, the configuration in which the light receiving diameter 42 can be adjusted by the aperture mechanism 45 has been described, but the present invention is not limited to this, and for example, the light receiving diameter φ2 may be adjusted by replacing the light receiving member 41 with a light receiving member having a different light receiving diameter. In this case, the aperture mechanism 45 is not necessary.

In addition, in the present embodiment, the configuration in which the fourth adjustment unit 54 can adjust the relative distance D4 from the incidence end surface 40a of the light receiving fiber 40 to the tablet W has been described, but the present invention is not limited to this, and for example, the distance D4 may be adjusted by replacing the light receiving member 41 with a light receiving member having a different length.

In addition, in the present embodiment, (1) the adjustment of the exposure time is described as an example of the adjustment item in the light quantity adjustment control, but the adjustment of the exposure time need not be the adjustment item. In this case, in the light quantity adjustment control, in a case where the light quantity is insufficient even in a case where one or more adjustment items of (2) to (9) are adjusted, the control device 2 may output an alarm. Further, the control device 2 may decrease the transport speed of the transport disk 11 after the alarm is output to increase the exposure time of the spectroscope 42. Accordingly, it is possible to deal with the insufficient light quantity.

Hitherto, the embodiment of the present invention has been disclosed, but it is clear that changes can be made by those skilled in the art without departing from the scope of the present invention. All such modifications and equivalents are intended to be included in the following claims.

### DESCRIPTION OF REFERENCE NUMERALS AND SIGNS

1: spectroscopic measurement device
2: control device
3: light source unit
4: light detection unit
5: spectral controller
10: article inspection device
11: transport disk (transport unit)
12: drive motor
21: operation display unit
30: light source
31: light guide
31a: emission end surface
32: light projecting member
32a: light projecting end
33: light source unit main body
34: aperture mechanism
40: light receiving fiber
40a: incidence end surface
41: light receiving member
41a: light receiving end
42: spectroscope
43: variable optical attenuator
44: light receiving section main body
45: aperture mechanism
51: first adjustment unit
52: second adjustment unit
53: third adjustment unit
54: fourth adjustment unit
W: tablet (article)
φ1: light projecting diameter
φ2: light receiving diameter

What is claimed is:

1. A spectroscopic measurement device comprising:
a light source unit configured to emit light from a light source toward an article; and
a light detection unit configured to measure a spectral characteristic of transmission light emitted from the light source unit and transmitted through the article with a spectroscope,
wherein the light source unit and the light detection unit are configured such that a relative distance from the light source unit to the article and a relative distance from the light detection unit to the article are adjustable as adjustment targets.

2. The spectroscopic measurement device according to claim 1,
wherein the light source unit and the light detection unit include actuators configured to adjust the relative distances to the article based on a control signal input from an outside.

3. The spectroscopic measurement device according to claim 1,
wherein the light detection unit includes a light receiving member including a light receiving end facing the article, and a light receiving fiber including an incidence end surface on which light transmitted through the light receiving member is incident, and the light receiving fiber is configured such that a relative distance from the incidence end surface to the article is adjustable as an adjustment target, and/or
the light source unit includes a light projecting member including a light projecting end facing the article, and a light guide configured to guide the light of the light source from the light source to the light projecting member and including an emission end surface from which the light is emitted, and the light guide is configured such that a relative distance from the emission end surface to the article is adjustable as an adjustment target.

4. The spectroscopic measurement device according to claim 3,
wherein the light detection unit and/or light source unit includes an actuator configured to adjust the relative distance to the article based on a control signal input from an outside.

5. The spectroscopic measurement device according to claim 1,
wherein the light detection unit includes a light receiving member including a light receiving end facing the article, and a light receiving fiber including an incidence end surface on which light transmitted through the light receiving member is incident, and the light receiving member is configured such that a light receiving diameter, which is a size of an opening on which light from the article is incident in the light receiving end, is adjustable as an adjustment target, and/or
the light source unit includes a light projecting member including a light projecting end facing the article, and a light guide configured to guide the light of the light source from the light source to the light projecting member and including an emission end surface from which the light is emitted, and the light projecting member is configured such that a light projecting diameter, which is a size of an opening from which the light from the light source is emitted in the light projecting end, is adjustable as an adjustment target.

6. The spectroscopic measurement device according to claim 5,
wherein the light detection unit and/or the light source unit includes an actuator configured to adjust the size of the opening based on a control signal input from an outside.

7. The spectroscopic measurement device according to claim 1,
wherein the light detection unit includes a variable optical attenuator configured to attenuate the transmission light transferred to the spectroscope and configured to vary an attenuation amount of the transmission light as an adjustment target, and/or
the light source is configured such that a light quantity of the emitted light is adjustable as an adjustment target.

8. An article inspection device comprising:
the spectroscopic measurement device according to claim 1; and
a control unit configured to adjust the adjustment targets,
wherein the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

9. An article inspection device comprising:
the spectroscopic measurement device according to claim 3; and
a control unit configured to adjust the adjustment targets,
wherein the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

10. An article inspection device comprising:
the spectroscopic measurement device according to claim 5; and
a control unit configured to adjust the adjustment targets,
wherein the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

11. An article inspection device comprising:
the spectroscopic measurement device according to claim 1;
an inspection unit configured to inspect a quality of the article based on the spectral characteristic measured by the spectroscope; and
a transport unit configured to transport the article to the spectroscopic measurement device,
wherein the article inspection device is configured such that an exposure time of the spectroscope is adjustable as an adjustment target by adjusting a transport speed of the transport unit.

12. An article inspection device comprising:
the spectroscopic measurement device according to claim 3;
an inspection unit configured to inspect a quality of the article based on the spectral characteristic measured by the spectroscope; and
a transport unit configured to transport the article to the spectroscopic measurement device,
wherein the article inspection device is configured such that an exposure time of the spectroscope is adjustable as an adjustment target by adjusting a transport speed of the transport unit.

13. An article inspection device comprising:
the spectroscopic measurement device according to claim 5;
an inspection unit configured to inspect a quality of the article based on the spectral characteristic measured by the spectroscope; and
a transport unit configured to transport the article to the spectroscopic measurement device,
wherein the article inspection device is configured such that an exposure time of the spectroscope is adjustable as an adjustment target by adjusting a transport speed of the transport unit.

14. The article inspection device according to claim 11, further comprising:
a control unit configured to adjust the adjustment targets,
wherein the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

15. The article inspection device according to claim 12, further comprising:
a control unit configured to adjust the adjustment targets,
wherein the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

16. The article inspection device according to claim 13, further comprising:
a control unit configured to adjust the adjustment targets,
wherein the control unit is configured to adjust the adjustment targets at predetermined adjustment intervals, respectively record spectra obtained by the spectroscope at the adjustment intervals, and set, as a light quantity adjustment value, an adjustment value of the adjustment targets corresponding to a spectrum in a case where a count value of a wavelength having a highest light quantity is equal to or less than a predetermined threshold value among the recorded spectra.

17. The article inspection device according to claim 14,
wherein the transport unit is configured to hold the article on an end surface different from an irradiation-side surface and a transmission-side surface and move the article.

18. The article inspection device according to claim 15,
wherein the transport unit is configured to hold the article on an end surface different from an irradiation-side surface and a transmission-side surface and move the article.

19. The article inspection device according to claim 16,
wherein the transport unit is configured to hold the article on an end surface different from an irradiation-side surface and a transmission-side surface and move the article.

20. The article inspection device according to claim 17,
wherein the article is a tablet.
